(19) United States
(12) Patent Application Publication
(10) Pub. No.: US 2012/0291748 A1
(43) Pub. Date: Nov. 22, 2012

(54) FUEL INJECTION SYSTEM

(75) Inventors: Motomasa IIZUKA, Anjo-city (JP); Kimitaka Saito, Nagoya-city (JP); Naoya Katoh, Nagoya-city (JP)

(73) Assignees: NIPPON SOKEN, INC., Nishio-city (JP); DENSO CORPORATION, Kariya-city (JP)

(21) Appl. No.: 13/471,744

(22) Filed: May 15, 2012

(30) Foreign Application Priority Data
May 16, 2011 (JP) 2011-109020

(51) Int. Cl. F02M 69/04

(52) U.S. Cl. 123/299; 123/294

(57) ABSTRACT

A fuel injector is provided in a cylinder block of a spark-ignition direct injection engine. The fuel injector is arranged in such a manner that a fuel injection port is closed by a piston of the engine when the piston is positioned at a top dead center. The fuel injection port is opened when the piston is positioned at a specified position which is far from the top dead center by a specified distance.

### CROSS-REFERENCE TO RELATED APPLICATION

This application is based on Japanese Patent Application No. 2011-109020 filed on May 16, 2011, the disclosure of which is incorporated herein by reference.

### TECHNICAL FIELD

The present disclosure relates to a fuel injection system applied to a spark-ignition direct injection engine.

### BACKGROUND

Generally, a fuel injector provided in a spark-ignition engine has a needle valve which opens/closes an injection port formed in an injector body. The needle valve is driven by an electromagnetic actuator. When the actuator is energized, the valve is biased to open the injection port. Further, the valve receives a biasing force from a spring in a direction in which the valve closes the injection port. A biasing force of the electromagnetic actuator is set larger than that of the spring.

In a case of a direct injection engine, since the injection port is arranged in a combustion chamber, high pressure of the fuel in the combustion chamber is applied to the needle valve. Thus, a set-load of the spring is necessary to be high in order that the needle valve surely closes the injection port when the electromagnetic actuator is deenergized.

Also, it is required for the actuator to have high driving force, which increases electric energy supplied to the electromagnetic actuator. As a result, an electric driver unit (EDU) which controls the electric energy supplied to the electromagnetic actuator is necessary besides an electronic control unit (ECU) which outputs a command signal to the actuator (refer to JP-2000-73840A and JP-2006-348842A (US-2006-0283424A1)).

### SUMMARY

It is an object of the present disclosure to provide a fuel injection system for a spark-ignition direct injection engine, which has a fuel injector of which set-load of a spring is decreased, whereby an EDU is not necessary or the EDU can be downsized.

According to the present disclosure, a fuel injection system is applied to a spark-ignition direct injection engine. The fuel injection system includes a fuel injector provided in a cylinder block of the engine for injecting a fuel into a combustion chamber of the engine through a fuel injection port. The fuel injector is arranged in such a manner that the fuel injection port is closed by a piston of the engine when the piston is positioned at a top dead center and the fuel injection port is opened when the piston is positioned at a specified position which is far from the top dead center by a specified distance.

According to another disclosure, a fuel injection system includes: a fuel injector injecting a fuel into a combustion chamber of the engine through a fuel injection port; an accommodation chamber formed in a cylinder head or a cylinder block of the engine for accommodating the fuel injector; and an opening-closing valve for opening and closing a communication port which communicates the accommodation chamber and the combustion chamber. The opening-closing valve opens the communication port when a pressure in the combustion chamber is less than the specified value, whereby the fuel is injected from the injection port into the combustion chamber through the communication port.

### BRIEF DESCRIPTION OF THE DRAWINGS

The above and other objects, features and advantages of the present disclosure will become more apparent from the following detailed description made with reference to the accompanying drawings. In the drawings:

FIGS. 1A and 1B are cross-sectional views showing a fuel injection system according to a first embodiment;

FIG. 2 is a cross-sectional view showing a fuel injector;

FIG. 3A is a time chart showing a fuel injection time according to the first embodiment;

FIGS. 3B, 3C, 3D, 3E, and 3F are cross-sectional view showing the fuel injection system;

FIG. 4 is a cross-sectional view showing a fuel injection system according to a second embodiment;

FIG. 5A is a cross-sectional view showing a fuel injection system according to a modification of the second embodiment;

FIG. 5B is a view in a direction of an arrow “A” in FIG. 5A;

FIG. 6A is a cross-sectional view showing a fuel injection system according to a third embodiment;

FIG. 6B is a view in a direction of an arrow “A” in FIG. 6A;

FIG. 7 is a cross-sectional view showing a top portion of an engine according to a third embodiment; and

FIG. 8 is a time chart showing a fuel injection time according to a third embodiment.

### DETAILED DESCRIPTION

Hereafter, embodiments of the present invention will be described. The same parts and components as those in each embodiment are indicated with the same reference numerals and the same descriptions will not be reiterated.

### First Embodiment

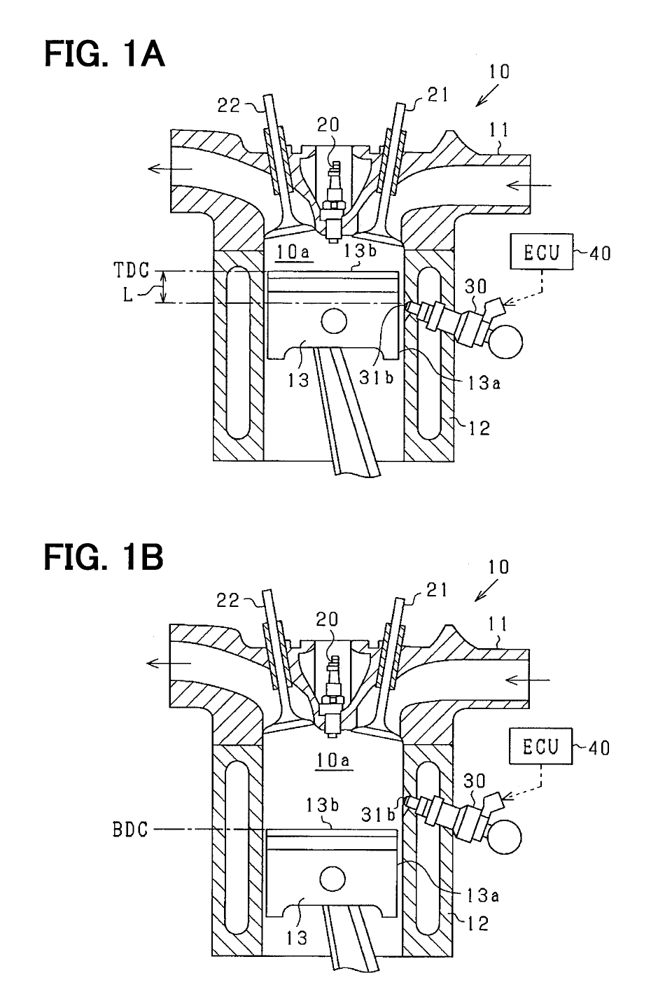

FIGS. 1A and 1B are cross sectional views schematically showing an engine 10. The engine 10 is a gasoline engine having a spark plug 20. Fuel gasoline is directly injected into a combustion chamber 10a from a fuel injector 30. The engine 10 includes a cylinder head 11, a cylinder block 12 and a piston 13.

The cylinder head 11 defines the combustion chamber 10a and is provided with a spark plug 20, an intake valve 21 and an exhaust valve 22. The cylinder block 12 defines a cylinder therein. The fuel injector 30 injecting the fuel into the combustion chamber 10a is provided in the cylinder block 12.

The spark plug 20 and the fuel injector 30 are operated by an electronic control unit (ECU) 40. The ECU 40 computes a fuel injection quantity, a fuel injection timing, a fuel ignite timing and the like, so that an engine output and exhaust emission are improved.

FIG. 1A shows a situation in which a piston 13 is positioned at a top dead center “TDC”. While the piston 13 is positioned between the “TDC” and a position apart from the “TDC by a distance “L”, an injection port 31b of the fuel injector 30 is closed by an outer surface 13a of the piston 13. That is, the injection port 31b is covered with the outer surface 13a. This situation is referred to as a close condition, hereinafter.

FIG. 1B shows a situation in which the piston 13 is positioned at a bottom dead center “BDC”. When the piston 13 slides down from the “TDC” by the distance “L”, the injection port 31b is opened. This situation is referred to as an open condition, hereinafter. In the close condition, the injection port 31b is positioned outside of the combustion chamber 10a. In the open condition, the injection port 31b is positioned inside of the combustion chamber 10a.

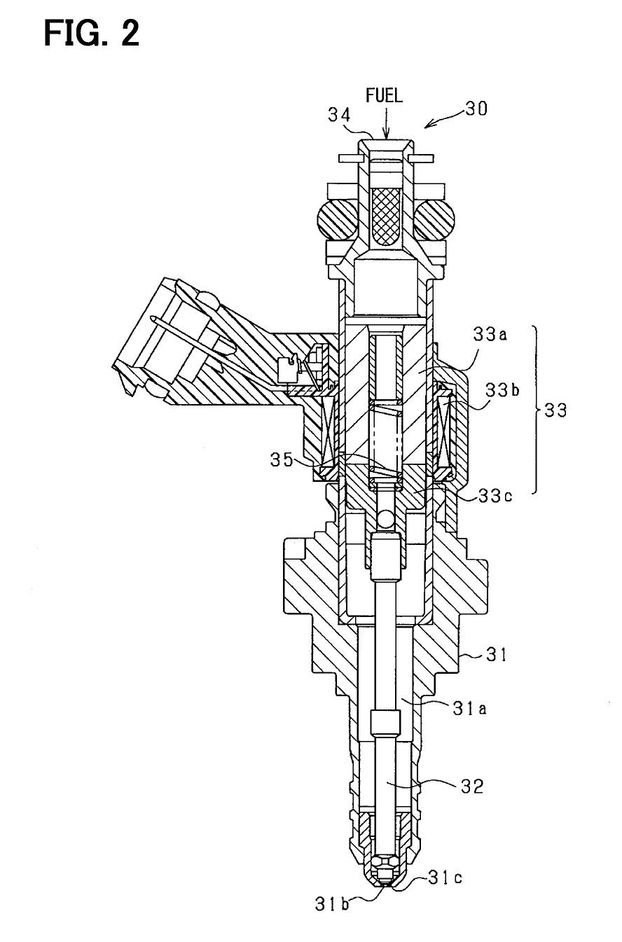

FIG. 2 is a cross sectional view of a fuel injector 30. The fuel injector 30 includes a valve body 31, a needle valve 32 and an electromagnetic actuator 33. The valve body 31 defines a fuel passage 31a therein and has the injection port 31b at its tip end. When the needle valve 32 moves away from a seat surface 31c, the high-pressure fuel supplied from a high-pressure port 34 flows through the fuel passage 31a. Then, the high-pressure fuel is injected into a combustion chamber 10a through the injection port 31b. When the needle valve 32 sits on the seat surface 31c, the injection port 31b is closed and the fuel injection is terminated.

The electromagnetic actuator 33 has a stator 33b including solenoid 33a and an armature 33c. When the actuator 33 is energized, the armature 33c is attracted by the stator 33b. The needle valve 32 connected to the armature 33c is moved away from the seat surface 31c against a biasing force of the spring 35. That is, while the solenoid 33a is energized, the fuel is injected through the injection port 31b. The fuel injection quantity per one injection depends on an energizing period of the solenoid 33a. Meanwhile, when the solenoid 33a is deenergized, the needle valve 32 moves down by the spring 35 to sit on the seat surface 31c, whereby the fuel injection is terminated.

The fuel in a fuel tank (not shown) is supplied to a delivery pipe (not shown). Then, the high-pressure fuel accumulated in the delivery pipe is supplied to the high-pressure port 34 of the fuel injector 30 of each cylinder.

A biasing force of the spring 35 is applied to the needle valve 32 in a valve-close direction. When the solenoid 33a is energized, a driving force of the actuator 33 is applied to the valve needle 32 in a valve-open direction. Also, a combustion pressure in the combustion chamber 10a is applied to an end surface of the needle valve 32 in a valve-open direction. Therefore, the set-load of the spring 35 is set larger than the combustion pressure, so that the needle valve 32 is not opened when the solenoid 33a is deenergized.

It should be noted that the injection port 31b is closed when the combustion pressure is high, as shown in FIG. 1A. Thus, the set-load of the spring 35 can be set lower as if the combustion pressure is low as shown in FIG. 1B.

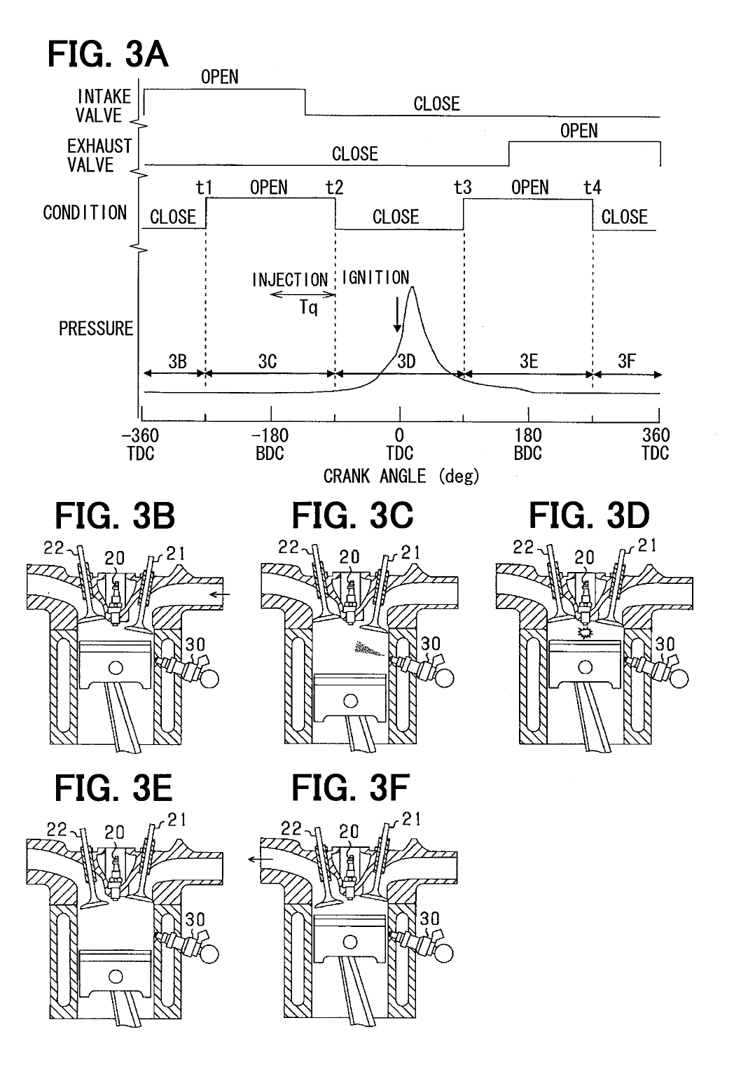

FIG. 3A is a time chart showing a relationship between a timing at which condition is switched between the close condition and the open condition and a variation in combustion pressure. Specifically, FIG. 3A shows a valve-opening timing of the intake valve 21, a valve-opening timing of the exhaust valve 22, a condition switch timing, and a variation in combustion pressure.

In a lower part of FIG. 3A, a range of the combustion pressure denoted by “3B” represents an engine condition shown in FIG. 3B, where the piston 13 starts to slide down from the “TDC”. That is, an intake stroke is started. The ranges “3C”, “3D”, “3E” and “3F” respectively show the engine condition shown in FIGS. 3C to 3F. After the piston 13 slides down more than the distance “L”, which is denoted by “3C”, the engine condition becomes the open condition at a time t1. Then, when the piston 13 starts to move up from the bottom dead center “BDC”, the engine condition is changed from a condition shown in FIG. 3C to a condition shown in FIG. 3D at a time t2.

Therefore, in a period from the time t1 to a time t2, the fuel injector 30 can inject the fuel into the combustion chamber 10a. In this period, the needle valve 32 is opened only during an injecting time period Tq corresponding to a target injection quantity.

Then, at a time close to the “TDC”, the spark plug 20 ignites air-fuel mixture in the combustion chamber 10a. The power stroke is started. When the piston 13 slides down from the “TDC” by the distance “L” at a time t3, the engine condition is changed from a condition shown in FIG. 3D to a condition shown in FIG. 3E. Then, when the piston 13 slides up from the “BDC”, the exhaust stroke is started and the engine condition is changed from a condition shown in FIG. 3E to a condition shown in FIG. 3F at a time t4.

As above, when the pressure in a cylinder becomes higher in a period from the time t2 to the time t3, the engine condition is switched into the close condition. The combustion pressure is not applied to the needle valve 32, whereby the set-load of the spring 35 can be set lower. Therefore, an EDU is unnecessary. Alternatively, the size of the EDU can be made smaller. Also, by decreasing the set-load of the spring 35, the size of the electric actuator 33 can be made smaller.

Meanwhile, when the pressure in a cylinder becomes lower in a period from the time t1 to the time t2, the engine condition is switched into the open condition. Thus, the needle valve 32 is opened and the fuel is directly injected into the combustion chamber 10a through the injection port 31b.

### Second Embodiment

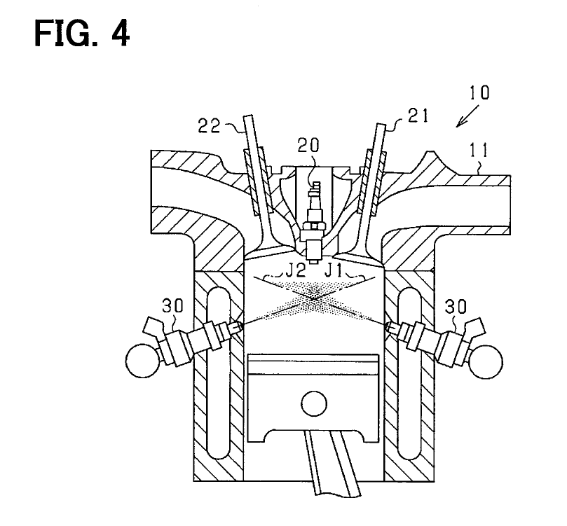

According to a second embodiment, as shown in FIG. 4, two fuel injectors 30 are provided to each cylinder. Injection ports of these fuel injectors 30 can be closed by the outer surface 13a of the piston 13 in the same manner as the first embodiment.

Each of the fuel injectors 30 is arranged in the cylinder block 12 at the same position in a sliding direction of the piston 13, so that the injection ports 31b of the fuel injectors 30 are closed or opened at the same time.

Furthermore, the injection ports 31b are arranged in such a manner as to confront to each other. For example, two fuel injectors 30 are arranged in such a manner that a center line “J1” of fuel spray and a center line “J2” of fuel spray cross in the combustion chamber 10a. Alternatively, the line “J1” and the line “J2” may be on the same line.

During a period from the time t2 to t3 (close condition), the fuel can not be injected. Only a period from the time t1 to t2 (open condition), the fuel can be injected. When the engine speed is high and the period from the time t1 to t2 is short, it is likely that a fuel injection quantity per one combustion cycle may be insufficient.

According to the present embodiment, since multiple (two) fuel injector 30 are provided, the desired fuel quantity can be injected into the combustion chamber 10a through multiple injection ports 31b. Thus, during a period from the time t1 to t2 (open condition), the sufficient fuel quantity can be injected.

Furthermore, since tow fuel injectors 30 are arranged in such a manner that the center line “J1” of fuel spray and the center line “J2” of fuel spray cross in the combustion chamber 10a, the fuel spray collide with each other in the combustion chamber 10a before reaching an inner wall of the cylinder block 12. Thus, a penetrating force of the fuel spray is reduced, whereby fuel quantity adhering to a cylinder wall can be reduced. As a result, the quantity of unburned fuel contained in the exhaust can be reduced.

### Modification of Second Embodiment

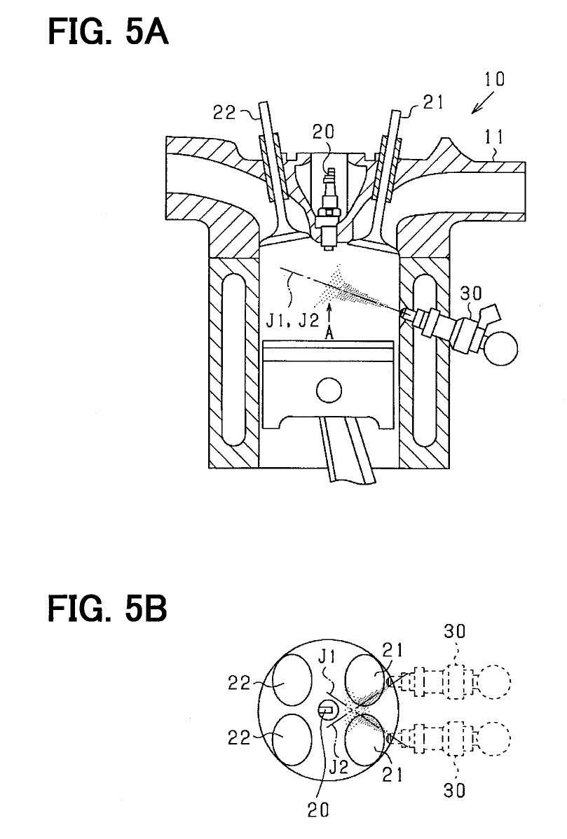

As shown in FIGS. 5A and 5B, two fuel injectors 30 are arranged adjacently in a circumferential direction of the cylinder block 12. FIG. 5B is a view in a direction of an arrow “A” in FIG. 5A.

The injection ports 31b are arranged in such a manner that the line “J1” and the line “J2” cross in the combustion chamber 10a. The fuel spray collides with each other in the combustion chamber 10a before reaching an inner wall of the cylinder block 12. Thus, a penetrating force of the fuel spray is reduced, whereby fuel quantity adhering to a cylinder wall can be reduced. As a result, the quantity of unburned fuel contained in the exhaust can be reduced.

### Third Embodiment

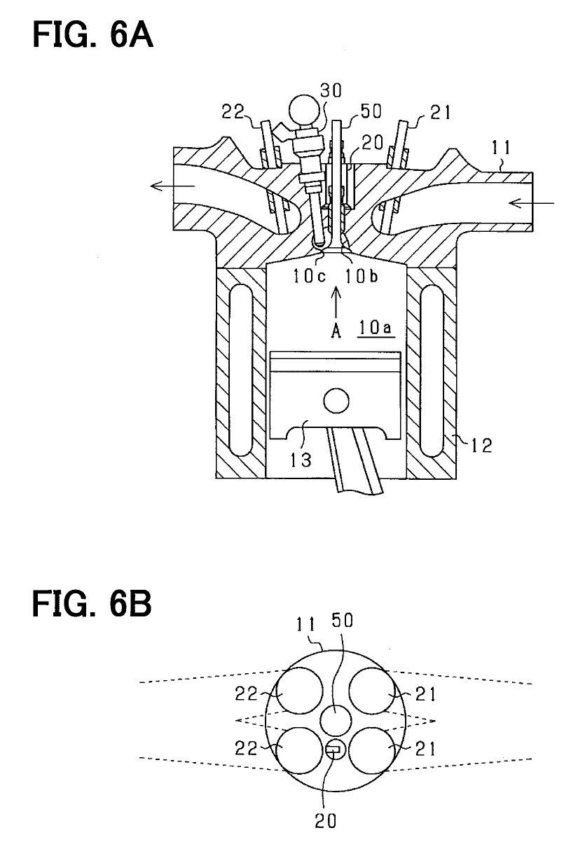

As shown in FIGS. 6 to 8, the fuel injector 30 is provided in the cylinder head 11.

Specifically, an accommodation chamber 10b is formed in the cylinder head 11. The injection port 31b of the fuel injector 30 is positioned in the accommodation chamber 10b. The accommodation chamber 10b has a communication port 10c communicating with the combustion chamber 10a. An opening-closing valve 50 can open or close the communication port 10c.

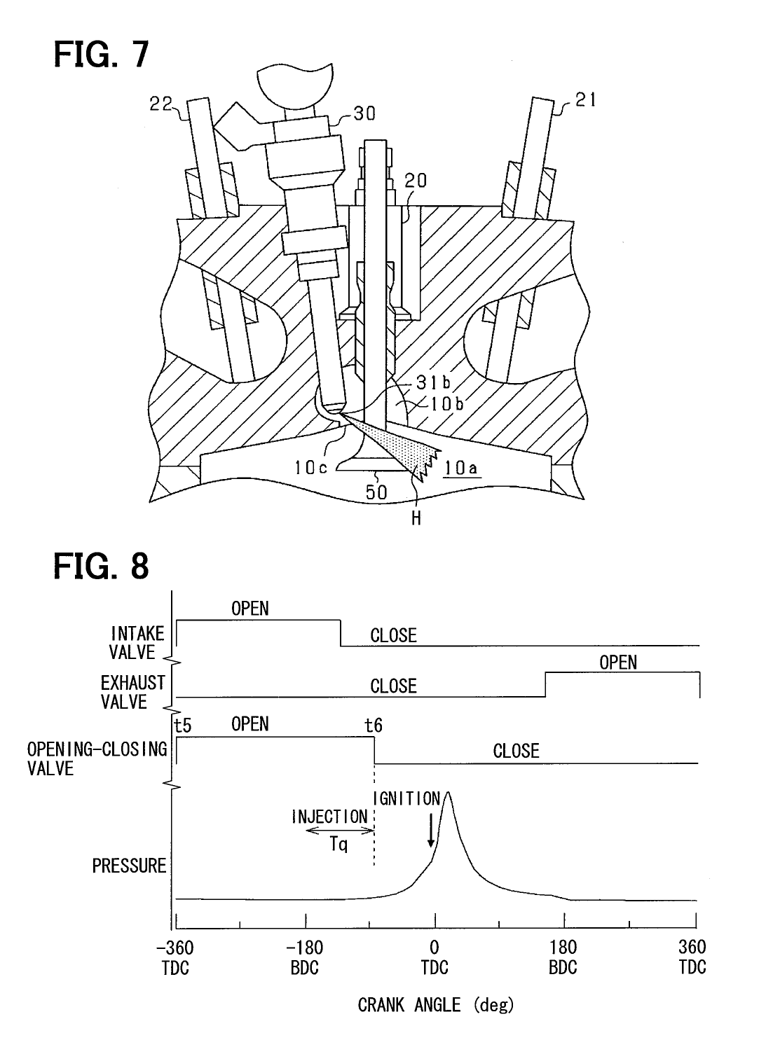

FIGS. 6A and 6B show a close condition in which the opening-closing valve 50 closes the communication port 10c. FIG. 7 shows an open condition in which the opening-closing valve 50 opens the communication port 10c. In this open condition, the fuel injector 30 injects the fuel into the combustion chamber 10a through the communication port 10c. The fuel spray injected from the injection port 31b is denoted by “H” in FIG. 7. The injection port 31b is positioned at a vicinity of the communication port 10c in such a manner that the fuel spray “H” is not in contact with the communication port 10c.

FIG. 6B is a view in a direction of an arrow “A” in FIG. 6A. The opening-closing valve 50 is driven by a crankshaft of the engine 10 as well as the intake valve 21 and the exhaust valve 22. Thus, the communication port 10c opens during a specified time period in one combustion cycle. The combustion pressure is applied to the opening-closing valve 50 in a valve-close direction.

FIG. 8 is a time chart showing a relationship between a timing at which condition is switched between the close condition and the open condition and a variation in combustion pressure. Specifically, FIG. 8 shows a valve-opening timing of the intake valve 21, a valve-opening timing of the exhaust valve 22, a switch timing of the opening-closing valve 50, and a variation in combustion pressure.

When the pressure in the combustion chamber 10a is greater than or equal to a specified value, the opening-closing valve 50 is closed. When the pressure in the combustion chamber 10a is less than the specified value, the opening-closing valve 50 is opened during a period from a time t5 to a time t6.

Therefore, in a period from the time t5 to a time t6, the fuel injector 30 can inject the fuel into the combustion chamber 10a. In this period, the needle valve 32 is opened only during an injecting time period Tq corresponding to a target injection quantity.

As above, when the pressure in a cylinder becomes higher, the opening-closing valve 50 is closed and the engine condition is switched into the close condition. The combustion pressure is not applied to the needle valve 32, whereby the set-load of the spring 35 can be set lower. Therefore, an EDU is unnecessary. Alternatively, the size of the EDU can be made smaller. Also, by decreasing the set-load of the spring 35, the size of the electric actuator 33 can be made smaller.

Meanwhile, when the pressure in a cylinder becomes lower in a period from the time t5 to the time t6, the opening-closing valve 50 is opened and the engine condition is switched into the open condition. Thus, the needle valve 32 is opened and the fuel is directly injected into the combustion chamber 10a through the injection port 31b.

### Other Embodiment

The present invention is not limited to the embodiments described above, but may be performed, for example, in the following manner. Further, the characteristic configuration of each embodiment can be combined.

In the above embodiments, the ECU 40 controls the electric actuator 33. However, instead of the ECU 40, an EDU may control the electric actuator 33. Even in this case, the size of the actuator 33 can be reduced, whereby the size of the EDU can be reduced.

In the above embodiments, the needle valve 32 is directly driven by the actuator 33. However, the fuel injector 30 may be configured in such a manner that a back pressure is applied to the needle valve 32 in a valve-close direction. The back pressure is adjusted by another control valve.

The electric actuator 33 controls the control valve to adjust the back pressure. When the actuator 33 is energized to open the control valve, the back pressure is decreased, whereby the needle valve 32 is opened to inject the fuel. When the actuator 33 is deenergized to close the control valve, the back pressure is increased, whereby the needle valve 32 is closed to terminate the fuel injection.

In the third embodiment, the fuel injector 30 and the opening-closing valve 50 is provided in the cylinder head 11. Alternatively, the fuel injector 30 and the opening-closing valve 50 may be provided in the cylinder block 12.

What is claimed is:

1. A fuel injection system applied to a spark-ignition direct injection engine, comprising:
a fuel injector provided in a cylinder block of the engine for injecting a fuel into a combustion chamber of the engine through a fuel injection port; wherein:
the fuel injector is arranged in such a manner that the fuel injection port is closed by a piston of the engine when the piston is positioned at a top dead center and the fuel injection port is opened when the piston is positioned at a specified position which is far from the top dead center by a specified distance.

2. A fuel injection system according to claim 1, wherein:
a plurality of fuel injectors are provided in the cylinder block.

3. A fuel injection system according to claim 2, wherein:
the fuel injectors are arranged in such a manner that fuel spray injected from each fuel injector collides with each other before reaching an inner wall of the combustion chamber.

4. A fuel injection system applied to a spark-ignition direct injection engine, comprising:
a fuel injector injecting a fuel into a combustion chamber of the engine through a fuel injection port;
an accommodation chamber formed in a cylinder head or a cylinder block of the engine for accommodating the fuel injector; and
an opening-closing valve for opening and closing a communication port which communicates the accommodation chamber and the combustion chamber; wherein
the opening-closing valve closes the communication port when a pressure in the combustion chamber is greater than or equal to a specified value; and
the opening-closing valve opens the communication port when a pressure in the combustion chamber is less than the specified value, whereby the fuel is injected from the injection port into the combustion chamber through the communication port.
